(19) United States
(12) Patent Application Publication
(10) Pub. No.: US 2017/0247068 A1
(43) Pub. Date: Aug. 31, 2017

(54) Vehicle Comprising a Track Device

(71) Applicants: Felix Paludan Ratgen, Vejen (DK); Michael Toftmann Schmidt, Rødding (DK)

(72) Inventors: Felix Paludan Ratgen, Vejen (DK); Michael Toftmann Schmidt, Rødding (DK)

(21) Appl. No.: 15/467,787

(22) PCT Filed: Sep. 28, 2015
(86) PCT No.: PCT/DK2015/050294

§ 371 Date: Mar. 23, 2017

(30) Foreign Application Priority Data
Sep. 28, 2014 (PA) PA 2014 00551

(51) Int. Cl. B62D 55/02; B62D 49/06

(52) U.S. Cl. CPC B62D 55/02; B62D 49/0635

(57) ABSTRACT

A vehicle comprising at least a first wheel (6) mounted in a first side area of the vehicle and a second wheel (6′) mounted in a second side area of the vehicle is disclosed. The vehicle comprises a track device (8) configured to be brought into engagement with the ground (10). The vehicle comprises a control member (32) configured to adjust the pressure with which the track device engages the ground, wherein the pressure is determined on the basis of measurements performed by one or more detection members configured to detect one or more variable parameters of the vehicle or external information received by the vehicle.

### FIELD OF INVENTION

The present invention generally relates to a vehicle comprising a track device. The invention more particularly relates to a vehicle configured to control the pressure with which the track device engages the ground.

### PRIOR ART

When driving a vehicle on stable ground (e.g. a road), it is optimum to reduce the vehicle-ground contact area in order to minimise the friction and wear on the wheels. This is typically achieved by applying a large tyre pressure and/or by reducing the number of wheels in order to reduce the vehicle-ground contact area.

However, when driving a vehicle in a field, it is beneficial to have a large vehicle-ground contact area in order to reduce the pressure exerted against the ground (e.g. to reduce damage caused by the driving operation). This may be done by mounting additional wheels on the vehicle or by decreasing the tyre pressure in order to achieve more “flat” tyres. An alternative is to apply a tracked vehicle equipped with tracks. Hereby, the vehicle is able to reach all destinations without damaging the ground even if the ground is soft. Further, the vehicle can be loaded to a greater extent.

In several countries, farmers aim for driving into the fields as early as possibly in the spring time. However, mud in the fields makes it impossible to drive in the fields with heavy agricultural machinery without damaging the fields. Both with the purpose of protecting a field from damage caused by high pressure exerted against the ground by the agricultural machinery, and with the purpose of getting driving access to a field in the spring time, and with the purpose of increasing the total load of the agricultural machinery without damaging the ground, it is necessary to be able to lower the pressure exerted against the ground by the agricultural machinery. It is well known that soil compaction— which is the process in which a stress applied to a soil causes densification as air is displaced from the pores between the soil grains—is a serious problem for farmers. Soil compaction is often the result of heavy machinery, such as agricultural machinery compressing the soil.

Therefore, it is an object of the invention to provide a vehicle by means of which it is possible to control (and e.g. lower) the pressure exerted by the wheels and track device of the vehicle against the ground in order to prevent soil compaction.

Due to the fact that agricultural machinery has to drive both on stable ground and in a field, one has to make a compromise in order to provide a solution that satisfies both ground conditions (stable ground driving and field driving). Therefore, the prior art vehicles are not well-suited for both driving on solid ground and in fields. Furthermore, when using prior art tracked and wheeled vehicles, there is risk for experiencing a situation in which the pressure exerted against the ground by the tracks exceeds the required pressure exerted by the wheels against the ground for providing a sufficiently large normal force for maintaining a sufficiently large road grip. Furthermore, it is desirable to be able to control the pressure which the tracks and wheels exert on the ground e.g. during varying driving conditions (varying ground characteristics or load conditions). Accordingly, there is need for an improved vehicle and a method to control the pressure which the tracks and wheels exert on the ground.

Therefore, it is an object of the present invention to provide a vehicle where the pressure with which the track device engages the ground can be controlled. It is moreover an object of the present invention to provide a vehicle where the pressure with which the track device engages the ground can be controlled in a manner that secures that the vehicle is always capable of driving when the tracks exert a pressure on the ground e.g. in order to prevent soil compaction.

It is a further object of the present invention to provide a method to control a tracked vehicle in order to control the pressure which the tracks and wheels exert on the ground and to allow driving when the tracks are activated.

Moreover, the prior art tracked vehicles are provided with track devices arranged in areas of the vehicle that makes it difficult to turn the vehicle. Accordingly, it is an object of the present invention to provide an easy turnable vehicle. Thus, there is a need for a vehicle which reduces or even eliminates the above-mentioned disadvantages of the prior art.

### SUMMARY OF THE INVENTION

The object of the present invention can be achieved by a vehicle as defined in claim 1. Preferred embodiments are defined in the dependent sub claims, explained in the following description and illustrated in the accompanying drawings.

The vehicle according to the invention is a vehicle comprising at least a first wheel mounted in a first side area of the vehicle and a second wheel mounted in a second side area of the vehicle, which vehicle comprises a track device configured to be brought into engagement with the ground, wherein the vehicle comprises a control member configured to adjust the pressure with which the track device engages the ground, wherein the pressure is determined on the basis of measurements performed by one or more detection members configured to detect one or more variable parameters of the vehicle or external information received by the vehicle.

Hereby, it is possible to provide a vehicle in which the pressure with which the track device and the wheels engage the ground can be controlled and wherein driving is possible when the tracks are activated. The pressure with which the track device and the wheels engage the ground can be controlled on the basis of measurements performed by one or more detection members or external information received by the vehicle. The vehicle hereby makes it possible to avoid soil compaction.

The vehicle according to the invention is a vehicle comprising at least a first wheel mounted in a first side area of the vehicle and a second wheel mounted in a second side area of the vehicle. The first side area may be the left side of the vehicle, whereas the second side area may be the right side of the vehicle or vice versa.

The vehicle may comprise one or more wheels in the first side area and may comprise one or more wheels in the second side area.

The vehicle may be agricultural machinery such as a tractor, a slurry tanker) a manure spreader, a cutter wagon, a combine harvester, a forage wagon, a bead harvester, a potato harvester, a sprayer, a tractor trailer, a crop sprayer or a forester vehicle by way of example.

The vehicle comprises a track device configured to be brought into engagement with the ground. The track device may be any suitable type of track device or belt (also known as continuous track or caterpillar track). The track device may also be a unit comprising a plurality of rotatably mounted wheels or idlers configured to be brought into engagement with the ground.

It may be an advantage that the one or more variable parameters of the vehicle are one or more of the following:
a) the slippage and/or road grip of one or more of the wheels;
b) the axle load and/or the load of the vehicle or of a container of the vehicle;
c) the tyre pressure of one or more of the wheels;
d) the measured motor power and/or the velocity of the vehicle.
e) the visual detection of the content in a container;
f) the pressure in a structure;
g) the distance from a predefined position to an object (e.g. a fluid or the content of a container).

By detecting the slippage and/or road grip of one or more of the wheels, it is possible to adjust the pressure with which the track device engages the ground in order to secure that the normal force acting on the wheels is sufficiently large. It may be an advantage that the slippage and/or road grip of one or more of the wheels is measured on a continuous basis. Furthermore, it may be beneficial that slippage and/or road grip is detected for several wheels. In one embodiment according to the invention, the slippage and/or road grip is detected for all wheels.

The slippage and/or road grip may be detected by measuring the speed of the vehicle and the ground engaging portion of the wheel. The speed of the ground engaging portion of the wheel may be determined by measuring the rotational speed of the wheel or by means of a velocity sensor.

In one embodiment according to the invention, the vehicle is capable of minimising the pressure which any of the wheels or the track device exerts on the ground, and at the same time, securing a sufficient grip to drive the vehicle by means of the wheels. Hereby, the track device does not need to be provided with a drive unit for driving the track device. Moreover, a high tyre pressure may be used.

By detecting the axle load and/or the load of the vehicle or of a container of the vehicle, it is possible to account for soil characteristics (e.g. a dry field or a sludge field). The axle load may be detected by means of load sensors such as strain gauges. Alternatively, the axial load may be detected by means of one or more pressure sensors or weighing sensors.

The load of the vehicle or of a container of the vehicle may be measured by one or more weighing sensors. By way of example, the weight of a tractor trailer or a flatbed may be detected by means of one or more strain gauges, pressure sensors or weighing sensors.

In one embodiment of a vehicle according to the invention, the control member is configured to (preferably on a continuous basis) provide a constant pressure exerted by the wheels on the ground by regulating the pressure exerted by the track device on the ground, when the load of a vehicle varies. This may be achieved by measuring the load (e.g. the load of a trailer, tank or another container of a vehicle) and adjusting the pressure with which the track device engages the ground. If load is added to the vehicle (e.g. a slurry spreader, a cutter wagon or a combine harvester), the track device will automatically be regulated to provide a larger pressure towards the ground in order to reduce the pressure exerted by the wheels on the ground. The constant pressure exerted by the wheels on the ground may be defined to maximum 0.5 kg/cm² or 1.0 kg/cm².

For safety reasons, it may be beneficial to detect the tyre pressure of one or more of the wheels. This may be done by means of tyre pressure sensors that may be configured to communicate wirelessly with a central control unit of the vehicle. It may be an advantage that the track device is configured to be automatically brought into engagement with the ground and support the vehicle in case that a tyre pressure drop is detected.

By measuring the motor power and/or the velocity of the vehicle, it is possible to detect the external “resistance” e.g. when a farmer is harrowing a field. If the harrow pulls the vehicle into the ground, the resistance will increase, and thus it may be an advantage to bring the track device into engagement with the ground and use the control member to increase the pressure with which the track device engages the ground. Hereby, the harrow may be moved upwards in order to reduce the resistance and hereby reduce the energy consumption by increasing the fuel economy.

Visual detection of the content in a container may be carried out by means of any suitable visual detection means including cameras. Hereby, it is possible to detect the content of a trailer, wagon or tank for the purpose of regulating the pressure with which the track device engages the ground.

It is possible to detect the pressure in a structure in order to regulate the pressure with which the track device engages the ground on the basis of this pressure. The pressure may be measure in any suitable structure of the vehicle e.g. in a hydraulic system of the vehicle.

It is possible to measure the distance from a predefined position to an object in order to determine the load of a trailer, wagon or tank loaded with e.g. wheat, sand of a fluid. It is possible to carry out distance measurements of the level in a trailer, wagon, manure spreader tank og a grain tank of a combine harvester by way of example. By detecting the level, the load and thus the pressure with which the wheels engage the ground can be estimated. Accordingly, the pressure with which the track device shall engage the ground (e.g. for reducing the the pressure with which the wheels engage the ground) can be determined.

It may be advantageous that the vehicle comprises a control member configured to adjust the pressure with which the track device engages the ground on the basis of geographical data measured by a sensor member of the vehicle or received by the vehicle. Hereby, the track device may be used in dependency of geographical data allowing the track device of the vehicle to be controlled in a manner in which soil characteristics (e.g. a dry field or a sludge field) can be taken into account.

The sensors and/or detection members may be configured to communicate wirelessly with a central control unit being part of the control member of the vehicle. Furthermore, it may be an advantage that the central control unit is directly or indirectly connected to and adapted to control one or more activation devices.

It may be advantageous that the vehicle comprises means for bringing the track device into a configuration in which the track device is not in engagement with the ground. Hereby, the vehicle is configured to be driven on solid ground such as asphalt only by means of the wheels.

It may be advantageous that the track device comprises drive means for driving the track device. Hereby, it is possible to increase the mobility of the vehicle. In case the vehicle is a non-motorised vehicle, the vehicle may be provided with drive means enabling the vehicle to be used in more demanding applications.

The drive means may be a hydraulic motor or actuator configured to be connected to the hydraulic system of the vehicle or to the hydraulic system of a motorised vehicle pulling the non-motorised vehicle.

The drive means may be an electric motor or actuator configured to be connected to the electric system of the vehicle or to the electric system of a motorised vehicle pulling the non-motorised vehicle.

It may be an advantage that the track device is detachably mounted to the vehicle. Hereby, it is possible to apply the same track device on several different vehicles by turns. It may be an advantage that the track device is configured to be hydraulically and/or electrically connected to different vehicles.

By using a detachably mounted track device, the track device may be installed subsequently.

It may be an advantage that the vehicle comprises control means configured to adjust and/or control the pressure with which the track device engages the ground. Hereby, it is possible to adjust and/or control the pressure of the vehicle towards the ground and meet requirements e.g. made by authorities or to avoid damage to crops.

It may be an advantage that the track device comprises a hydraulic and/or electrical actuator configured to be connected to the hydraulic system of the vehicle and/or to the electric system of the vehicle. Hereby, it is possible to apply the existing system of the vehicle to drive the actuator(s) of the track device of the vehicle.

It may be beneficial that the vehicle comprises means for displacing the track device along an axis extending perpendicular to the direction of travel.

It may be beneficial that the vehicle comprises means for displacing the track device along a horizontal axis extending perpendicular to the direction of travel.

Hereby, the track device can be displaced in order to fit the specific distances between rows of cultivated plant (e.g. berry trees, beets, potatoes, wheat, oats, or corn and other grain crops).

It may be beneficial that the track device is movably, e.g. slidably arranged at the vehicle in such a manner that the track device may be rearranged. Hereby, it is possible to change the configuration of the track device relative to the vehicle if desired in that way allowing for increasing the stability of the vehicle.

It may be beneficial that the vehicle comprises means for ensuring that the track device engages the ground with a predefined pressure defined on the basis of measurements made by the vehicle, preferably a constant pressure. Hereby, it is possible to control the pressure with which the track device engages the ground.

It may be an advantage that the vehicle comprises means for ensuring that the track device engages the ground with a predefined constant pressure.

It may be beneficial that the track device is arranged below a shaft connecting the first wheel and the second wheel of the vehicle.

Hereby, it is possible to apply the track device to reduce the pressure with which the wheels engage the ground. The shaft does no need to be a rotating shaft. The shaft may be a rod member, to which the first and second wheels are rotatably mounted. Accordingly, each wheel may be driven by a separate motor. The shaft may have a rectangular (e.g. square) cross-section.

It may be advantageous that the track device is arranged to support a portion of the shaft that extends between the first wheel and the second wheel of the vehicle.

Accordingly, the track device can relieve the pressure with which the wheels engage the ground.

The method according to the invention is a method for controlling a tracked and wheeled vehicle comprising a track device configured to be brought into engagement with the ground, which vehicle comprises a control member configured to adjust the pressure with which the track device engages the ground, wherein the method comprises the steps of:
detecting one or more variable parameters measured by one or more detection members or receiving external information;
adjusting the pressure with which the track device engages the ground on the basis of the detected parameter(s) or external information received by the vehicle.

Hereby, it is possible to control the pressure with which the track device engages the ground in such a manner that the vehicle is always capable of driving when the tracks exert a pressure against the ground.

It may be advantageous that the one or more variable parameters measured by one or more detection members are one or more of the following:
a) the slippage and/or road grip of one or more of the wheels;
b) the axle load and/or the load of the vehicle or of a container of the vehicle;
c) the tyre pressure of one or more of the wheels;
d) the measured motor power and/or the velocity of the vehicle.
e) the visual detection of the content in a container;
f) the pressure in a structure;
g) the distance from a predefined position to an object (e.g. a fluid or the content of a container).

By applying the detected slippage and/or road grip of one or more of the wheels, it is possible to adjust the pressure with which the track device engages the ground in order to secure that the normal force acting on the wheels is sufficiently large. It may be an advantage that the slippage and/or road grip of one or more of the wheels is measured on a continuous basis. Furthermore, it may be beneficial that slippage and/or road grip is detected for several wheels. In one embodiment according to the invention, the slippage and/or road grip is detected for all wheels.

In one embodiment according to the invention, the one or more variable parameters measured is the pressure with which the track device and/or the wheels engage the ground. In one preferred embodiment according to the invention, the pressure is kept below a predefined maximum pressure limit of e.g. 1 kg/cm³.

By applying the detected axle load and/or the load of the vehicle or of a container of the vehicle, it is possible to account for soil characteristics (e.g. a dry field or a sludge field). The axle load may be detected by means of load sensors such as strain gauges. Alternatively, the axial load may be detected by means of one or more pressure sensors or weighing sensors.

By applying the detected tyre pressure of one or more of the wheels, the pressure exerted on the ground by the track device may be increased if a tyre pressure drop is detected.

By applying the detected motor power and/or the velocity of the vehicle, it is possible to determine the external “resistance” e.g. when a farmer is harrowing a field. The pressure exerted on the ground by the track device may be increased in order to lower the resistance caused by a harrow.

Visual detection of the content in a container may be carried out by means of any suitable visual detection means including cameras. Hereby, it is possible to detect the content of a trailer, wagon or tank for the purpose of regulating the pressure with which the track device engages the ground.

It is possible to detect the pressure in a structure in order to regulate the pressure with which the track device engages the ground on the basis of this pressure. The pressure may be measure in any suitable structure of the vehicle e.g. in a hydraulic system of the vehicle.

It is possible to measure the distance from a predefined position to an object in order to determine the load of a trailer, wagon or tank loaded with e.g. wheat, sand of a fluid. It is possible to carry out distance measurements of the level in a trailer, wagon, manure spreader tank og a grain tank of a combine harvester by way of example. By detecting the level, the load and thus the pressure with which the wheels engage the ground can be estimated. Accordingly, the pressure with which the track device shall engage the ground (e.g. for reducing the the pressure with which the wheels engage the ground) can be determined.

It may be an advantage that the method comprises the step of adjusting the pressure with which the track device engages the ground on the basis of geographical data measured by a sensor member of the vehicle or received by the vehicle. Hereby, it is possible to account for geographical data (e.g. country or region specific variations) when controlling the track device.

It may be beneficial that the geographical data comprises information about the soil type of the ground in the area below and/or around the vehicle. Hereby, it is possible to account for soil characteristics (e.g. a dry field or a sludge field) when controlling the track device. The geographical data may include stored data (e.g. saved from last year by the driver of the vehicle). The stored data may include driver adjustment made base on the driver.

It may be an advantage that the track device is mounted in the centre area between the first side area and the second side area in closer distance to the central portion of the vehicle than the first side area and the second side area. Hereby, it is possible to provide a vehicle that is easy to turn and navigate. The vehicle is easy to turn, and the weight of the vehicle can be distributed onto regions in a distance from the first side area and the second side area.

The central portion of the vehicle may be the longitudinal axis of the vehicle.

It may be beneficial that the vehicle is a non-motorised vehicle. A non-motorised vehicle may be a trailer or a sprayer by ways of example.

It may be advantageous that the track device comprises two parallel track device members. Hereby, it is possible to increase the total area even more.

The vehicle according to the invention may comprise one track device member and thus one belt or a number of wheels.

The vehicle according to the invention may comprise two track device members and thus two belts or two sets of wheels.

The vehicle according to the invention may comprise three track device members and thus three belts or three sets of wheels.

The vehicle according to the invention may comprise four or more track device members and four or more sets of wheels.

It may be an advantage that the track device comprises means for horizontally displacing the track device from a first position into one or more further horizontal positions within the vehicle (e.g. from the central portion of the vehicle to the lateral portion(s) of the vehicle).

It may be beneficial that the track device comprises a suspension member having an attachment member provided at the distal end, where the suspension member is attached to a connection member at the proximal end, which connection member comprises a first connection element and a second connection element.

It may be an advantage that the track device comprises at least one hydraulic actuator rotatably attached to the first connection element by means of a joint. The second connection element may be rotatably attached to the base member by means of one or more additional joints.

It may be an advantage that the track device is mounted in such a manner that the pressure from the vehicle towards the track device is provided in the medial region of the track device when the track device is brought into engagement with the ground.

It may be an advantage that the track device is mounted in such a manner that the pressure from the vehicle towards the track device is provided at the centre line within the medial region of the track device when the track device is brought into engagement with the ground.

It may be beneficial that the vehicle comprises means for ensuring that the track device engages the ground with a predefined pressure, preferably a constant pressure.

Hereby, it is possible to control the pressure by which the track device engages the ground.

It may be advantageous that the vehicle comprises one or more pressure compensators being in fluid communication with the track device.

Hereby, the pressure compensators can absorb shocks caused by the track device when being in contact with bumps and holes. The pressure compensators can absorb shocks by receiving or releasing hydraulic oil.

The compensators may be integrated in the track device.

One method according to the invention is a method for producing a track device, wherein the method comprises the step of applying a used tyre, preferably a tyre from a tractor, to produce the track device member of the track device.

It may be an advantage that the method comprises the step of cutting a used tyre, preferably a used tyre of a tractor, and applying it as the track device member in a track device of a vehicle according to the invention.

It may be beneficial that the method comprises the step of arranging the used tyre in a non-circular configuration, preferably a configuration in which the tyre is formed as a flat belt or a V-belt.

In one embodiment, the method according to the invention is a method for producing a track device of a vehicle according to the invention, wherein the method comprises the step of applying a used tyre, preferably a tyre from a tractor, to produce the track device member of the track device.

### DESCRIPTION OF THE DRAWINGS

The invention will become more fully understood from the detailed description given herein below. The accompanying drawings are given by way of illustration only, and thus, they are not limitative of the present invention. In the accompanying drawings:

FIG. 1 a) shows a schematic side view of a vehicle according to the invention;

FIG. 1 b) shows a schematic back view of the vehicle shown in FIG. 1 a);

FIG. 2 a) schematically shows a perspective view of a track device of a vehicle according to the invention;

FIG. 2 b) shows a schematic side view of another track device according to the invention;

FIG. 2 c) shows a perspective view of a track device of a vehicle according to the invention mounted on a tractor trailer;

FIG. 3 a) shows a perspective top view of a vehicle according to the invention;

FIG. 3 b) shows a schematic side view of a vehicle according to the invention in which the track device is in a raised position;

FIG. 3 c) shows a schematic side view of a vehicle according to the invention in which the track device is in a lowered position and thus supports the vehicle;

FIG. 4 a) shows a schematic bottom view of a track device of a vehicle according to the invention;

FIG. 4 b) shows a schematic top view of a track device of a vehicle according to the invention;

FIG. 4 c) shows a schematic view of a track device according to the invention seen from a second end;

FIG. 4 d) shows a schematic view of a track device according to the invention seen from a first end;

FIG. 5 a) shows a schematic view of a loaded prior art tractor trailer and the pressure exerted against the ground;

FIG. 5 b) shows a schematic view of a loaded tractor trailer according to the invention and the pressure exerted against the ground;

FIG. 5 c) shows a schematic view of an unloaded tractor trailer according to the invention and the pressure exerted against the ground;

FIG. 6 a) shows a schematic view of a motorised vehicle according to the invention;

FIG. 6 b) shows a schematic back view of a tractor trailer according to the invention;

FIG. 7 shows schematic views of how the configuration of a track device of a vehicle according to the invention can be changed;

FIG. 8 shows a diagram of a proportional, integral and derivative (PID) control system according to the invention;

FIG. 9 shows different views of a tractor trailer according to the invention;

FIG. 10 a) shows a first rotation device according to the invention

FIG. 10 b) shows a second rotation device according to the invention;

FIG. 10 c) shows a back view of a tractor trailer according to the invention;

FIG. 11 A) shows a schematic side view of a vehicle according to an embodiment of the invention in which the track device engages the ground

FIG. 11 b) shows a schematic side view of the vehicle shown in FIG. 11 b) in a configuration in which the track device does not engages the ground and

FIG. 11 c) shows a schematic view of a track device attached to a shaft extending between a first wheel and a second wheel.

### DETAILED DESCRIPTION OF THE INVENTION

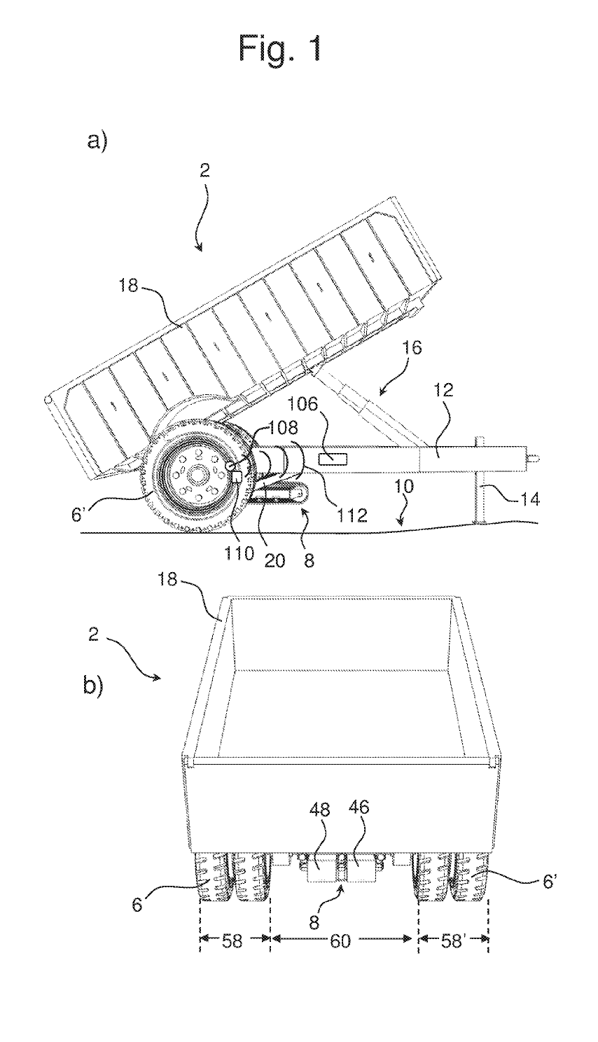

Referring now in detail to the drawings for the purpose of illustrating preferred embodiments of the present invention, a vehicle 2 of the present invention is illustrated in FIG. 1 a).

FIG. 1 a) illustrates a schematic side view of a vehicle 2 according to the invention. The vehicle 2 is a tractor trailer comprising a box member rotatably mounted to a frame member 12. A tipping member 16 extends between the frame member 12 and the back of the box member 18. The tipping member 16 is slidably arranged and configured to be extended hereby causing a tipping action needed to empty the box member 18. The tipping member 16 may be hydraulic powered; however, an electric actuator may be used as an alternative.

The vehicle 2 comprises a support member 14 resting on the ground 10 and being arranged at the front end of the vehicle 2. The vehicle 2 comprises two sets of wheels 6′ rotatably attached to the frame member 12. The vehicle 2 moreover comprises a track device 8 attached to the frame member 12. The track device 8 comprises a suspension member 20 extending between the frame member 12 and the lower portion of the track device 8.

The vehicle 2 comprises a control box 106 configured to activate activation means (e.g. a hydraulic cylinder or an electric actuator) in order to change the vertical position of the track device 8 and the pressure with which the track device 8 engages the ground 10. The vehicle 2 comprises a tyre pressure sensor 110 arranged at the wheel 6′ and a velocity sensor 108 also attached to the wheel 6′. The tyre pressure sensor 110 and the velocity sensor 108 are configured to wirelessly communicate with the control box 106. It is indicated that the tyre pressure sensor 110 and the velocity sensor 108 send wireless signals 112 to the control box 106.

Hereby, the tyre pressure sensor 110 and the velocity sensor 108 can detect pressure and velocity data and send the data to the control box 106. The control box 106 can determine if the pressure with which the track device 8 engages the ground 10 should be unchanged, be increased or be decreased.

The track device 8 may be lowered in order to bring it in contact with the ground 10 in order to reduce the peak pressure exerted against the ground 10 by the wheels 6′. The vehicle 2 is capable of preventing soil compaction.

The track device 8 may be equipped with drive means in order to motorise the vehicle 2. The drive means may be hydraulic or electric.

FIG. 1 b) illustrates a schematic back view of the vehicle 2 according to the invention shown in FIG. 1 a). The vehicle 2 comprises a first set of wheels 6 arranged in the left side area 58 of the vehicle 2 and a second set of wheels 6′ arranged in the right side area 58′ of the vehicle 2.

A track device 8 is arranged in the central area 60 between the left side area 58 of the vehicle 2 and the right side area 58′ of the vehicle 2. The track device 8 comprises a first track device member 46 and a second track device member 48. The first track device member 46 and the second track device member 48 extend parallel to each other.

The vehicle 2 comprises a box member 18 configured to receive items such as grain, waste or straw.

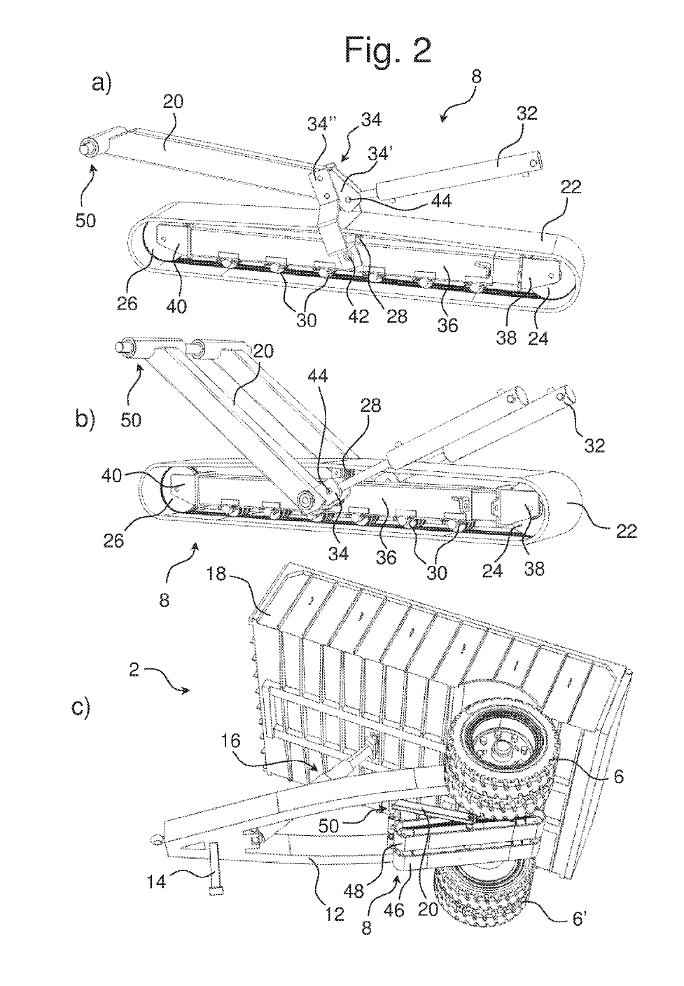

FIG. 2 a) illustrates a schematic perspective view of a track device 8 of a vehicle (not shown) according to the invention. The track device 8 comprises a base member 36 formed as an elongated rod member having a basically rectangular cross-section. A plurality of bottom support wheels 30 are rotatably attached to the base member 36.

The base member 36 comprises a first end portion 40 and a second end portion 38. A front wheel 26 is rotatably mounted to the second end portion 40, while a rear wheel 24 is rotatably mounted to the second end portion 38.

A top support wheel 28 is rotatably mounted to the base member 36.

The track device 8 comprises a track member 22 extending at the outside periphery of the bottom support wheels 30, the front wheel 26, the rear wheel 24 and the top support wheel 28. The track member 22 may be a terrain track. The track member 22 may be a portion (e.g. the mid portion) of a used tractor tyre.

Tensioning of the track device member 22 may be carried out by displacing the end portions 38, 40 axially relative to the base member 36 e.g. my beans of a mechanical screw member.

The track device 8 comprises a suspension member 20 having an attachment member provided at the distal end. At the proximal end, the suspension member 20, and??? a connection member 34 comprising a first connection element 34′ and a second connection element 34″ is attached.

The track device 8 comprises a hydraulic actuator 32 rotatably attached to the first connection element 34′ by means of a joint 44. The second connection element 34″ is rotatably attached to the base member 36 by means of joints 42 (only one is visible in FIG. 2 a).

The attachment member 50 is configured to be rotatably attached to the frame member of a vehicle (see FIG. 2 c). Similarly, the actuator 32 is configured to be rotatably attached to the frame member of a vehicle in its distal end.

When the track device 8 is attached to a vehicle (e.g. like illustrated in FIG. 2 c), the track device 8 may be activated by means of an electrical control box that may be electrically connected to e.g. one or more electrically controllable valves.

Accordingly, the vertical position of the base member 36 and thus the track device member 22 may be changed by means of the actuator 32.

FIG. 2 b) illustrates a side view of another track device 8 according to the invention. The track device 8 comprises some of the same element as the track device 8 shown in FIG. 2 a). The base member 36, the first end portion 40 and a second end portion 38 correspond to the ones shown in FIG. 2 a). Likewise, the track member 22, the front wheel 26, the rear wheel 24, the top support wheel 28 and the bottom support wheels 30 correspond to the ones used in the track device 8 shown in FIG. 2 a).

The track device 8 in FIG. 2 b), however, comprises two parallel extending hydraulic actuators 32 and two parallel extending suspension members 20. The hydraulic actuators 32 are rotatably attached to the connection members 34.

FIG. 2 c) shows a perspective view of a vehicle 2 according to the invention. The vehicle 2 is a tractor trailer comprising a track device 8 mounted on a basically V-shaped frame member 12 of the tractor trailer 2.

A first set of wheels 6 and a second set of wheels 6′ are rotatably mounted to the frame member 12. A support member 14 is provided near the front end of the frame member 12. A box member 18 is rotatably attached to the frame member 12, and an extendable tipping member 16 extends between the frame member 12 and the back of the box member 18.

The track device 8 comprises a first track device member 46 and a second track device member 48 corresponding to the ones shown in FIG. 2 b). It can be seen that the track device 8 comprises a suspension member 20 formed as an elongated rod with a rectangular cross-section. The suspension member 20 is mechanically attached to an attachment member 50 rotatably attached to the frame member 12.

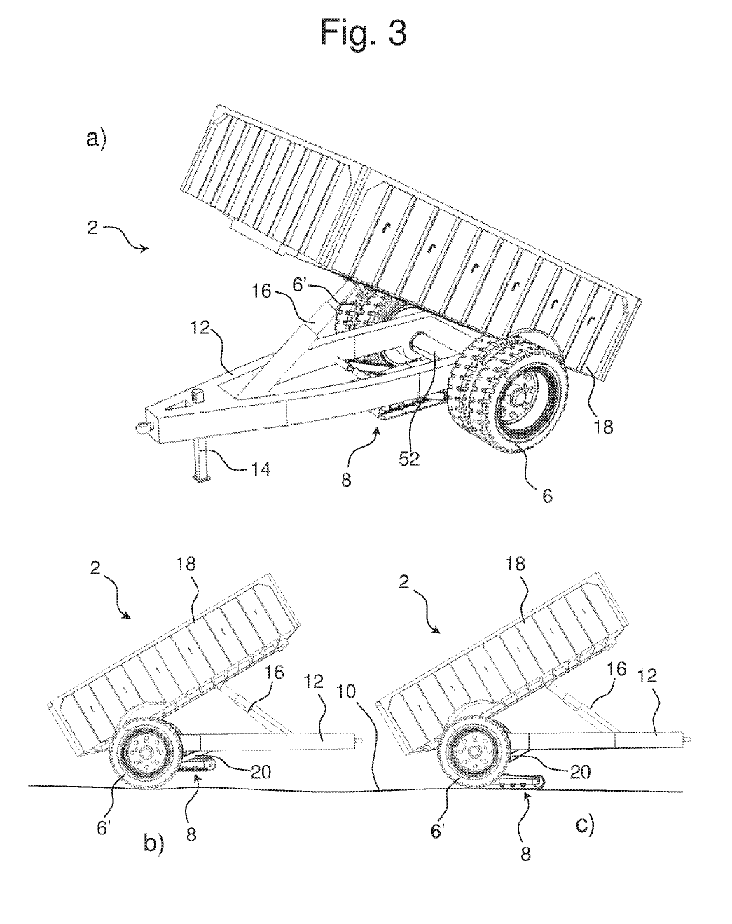

FIG. 3 a) illustrates a perspective top view of a vehicle 2 according to the invention. The vehicle 2 corresponds to the one shown in FIG. 2 c). The vehicle 2 is a tractor trailer comprising a first set of wheels 6 and a second set of wheels 6′ rotatably attached to the frame member 12 of the vehicle 2 by means of a shaft member 52 extending between the two set of wheels 6, 6′.

The vehicle 2 comprises a box member 18 that is brought into a tipping configuration by means of a tipping member 16 extending between the frame member 12 and the back of the box member 18.

The vehicle 2 rests on the two sets of wheels 6, 6′ and on the support member 14 slidably arranged within a corresponding channel provided in the front portion of the frame member 12.

The track device 8 is mounted in the same way as illustrated in FIG. 2 c).

FIG. 3 b) illustrates a side view of the vehicle 2 shown in FIG. 3 a). The vehicle 2 is seen from the right side. The vehicle 2 comprises two sets of wheels of which only one set 6′ is visible. A track device 8 is mounted at the frame member 12 of the vehicle 2 by means of a suspension member 20. The box member 18 has been arranged in a tipping configuration by extending the tipping member (hydraulic telescopic arm) 16 extending between the frame member 12 and the back of the box member 18.

The track device 8 is arranged at a distance from the ground 10. Accordingly, the track device 8 does not engage the ground 10. Therefore, in this configuration, the track device 8 does not decrease the peak pressure exerted against the ground 10 by the wheels 6′. However, when driving on stable ground (e.g. an asphalt road), it may be an advantage to lift up the track device 8 in order to bring the track device 8 into a position in which it does not engage the ground 10 (like illustrated in FIG. 3 b).

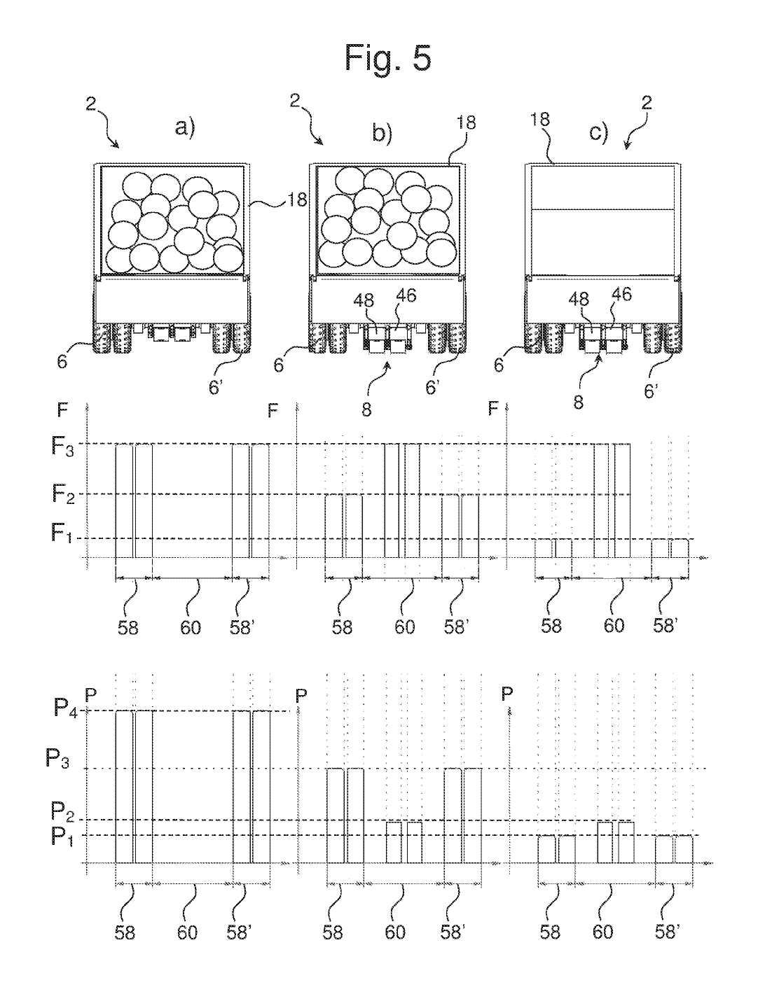

FIG. 3 c) illustrates a side view of the vehicle 2 shown in FIG. 3 a) and in FIG. 3 b). The only difference between FIG. 3 b) and FIG. 3 c) is that the track device 8 has been brought into engaging contact with the ground 10 in FIG. 3 c). Since the track device 8 engages the ground 10, the track device 8 reduces the peak pressure exerted against the ground 10 by the wheels 6′. This is explained in further detail with reference to FIG. 5. The vehicle 2 is capable of preventing soil compaction by reducing the pressure towards the ground.

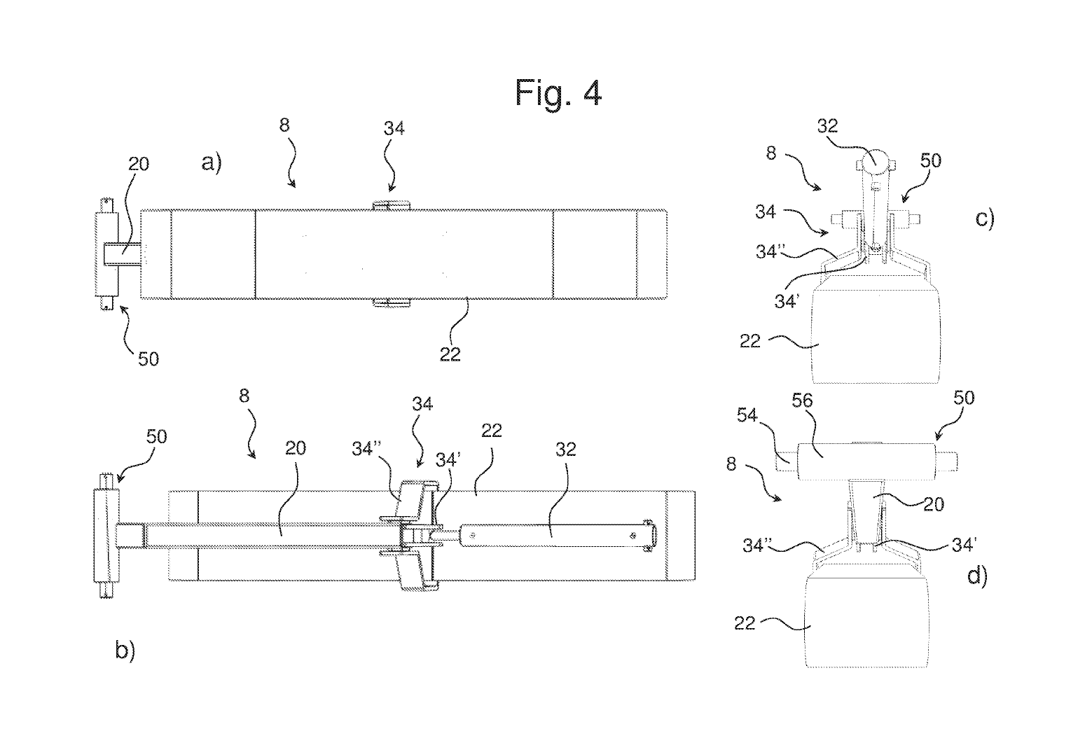

FIG. 4 a) illustrates a schematic bottom view of a track device 8 of a vehicle according to the invention. The track device 8 comprises a track member 22 and a connection member 34 arranged in the central portion of the track device 8.

A suspension member 20 mechanically attached to an attachment member 50 is provided at the end portion of the track device 8.

FIG. 4 b) illustrates a schematic top view of a track device 8 shown in FIG. 4 a). It can be seen that the connection member 34 comprises a first connection element 34′ and a second connection element 34″. The track device 8 comprises a suspension member 20 extending along the middle plane of the track device 8. The suspension member 20 is mechanically fixed to the second connection element 34″. The track device 8 comprises a hydraulic actuator 32 rotatably mounted to the first connection element 34′.

FIG. 4 c) illustrates a schematic view of the track device 8 shown in FIG. 4 a) and in FIG. 4 b) seen from a first end. The track device 8 comprises a track member 22 and a connection member 34 symmetrically arranged at the central portion of the track device 8. The connection member 34 comprises a first connection element 34′ and a second connection element 34″ symmetrically arranged. It can be seen that the attachment member 50 is also symmetrically arranged.

FIG. 4 d) illustrates a schematic view of the track device 8 shown in FIG. 4 c) seen from a second end. It can be seen that the attachment member 50 comprises a central portion 56 arranged between two end portions 54. The attachment member 50 is arranged at the distal portion of the suspension member 20 mechanically attached to the second connection element 34″.

FIG. 5 a) illustrates a schematic view of a prior art tractor trailer 2 loaded with rocks. Below the tractor trailer 2, a first and a second graph are shown. The first graph illustrates the force F exerted against the ground by the wheels 6, 6′. The first set of wheels 6 is arranged within a first side area 58 of the tractor trailer 2, whereas the second set of wheels 6′ is arranged within a second side area 58′ of the tractor trailer 2. No force is exerted against the ground within the centre area 60 provided between the first side area 58 of the tractor trailer 2 and the second side area 58′ of the tractor trailer 2.

The force F₃ exerted by the wheels 6, 6′ against the ground within the first side area 58 of the tractor trailer 2 and the second side area 58′ of the tractor trailer 2 is indicated in the first graph.

The pressure P₄ exerted against the ground by the first set of wheels 6 corresponds to the pressure exerted against the ground by the second set of wheels 6′.

FIG. 5 b) illustrates a schematic view of the tractor trailer 2 generally corresponding to the one shown in FIG. 5 a). The tractor trailer 2 shown in FIG. 5 b) is, however, equipped with a track device 8 according to the invention. Below the tractor trailer 2, a first and a second graph are shown. The first graph illustrates the force F exerted against the ground by the wheels 6, 6′ and the track device 8.

The first set of wheels 6 is arranged within a first side area 58 of the tractor trailer 2, and the second set of wheels 6′ is arranged within a second side area 58′ of the tractor trailer 2. The track device 8 is arranged in the centre area 60 between the first side area 58 of the tractor trailer 2 and the second side area 58′ of the tractor trailer 2.

The force F₃ exerted against the ground by the track device 8 in the centre area 60 is indicated. Similarly, the force F₂ exerted against the ground by the wheels 6 within the first side area 58 of the tractor trailer 2 and by the wheels 6′ within the second side area 58′ of the tractor trailer 2 is indicated in the first graph.

The second graph illustrates that the pressure P₃ exerted against the ground by the first set of wheels 6 corresponds to the pressure exerted against the ground by the second set of wheels 6′, and that this pressure P₃ is significantly lower than the pressure P₄ exerted against the ground by the wheels 6, 6′ in the prior art tractor trailer 2 illustrated in FIG. 5 a). Moreover, the second graph illustrates that the pressure P₂ exerted against the ground by the track device is significantly lower than the pressure P₃ exerted against the ground by the wheels 6, 6′.

In FIG. 5 b), it can be seen that the track device 8 comprises a first track device member 46 and a second track device member 48. The track device 8 is brought into engagement with the ground, and thus the pressure P₃ exerted against the ground by the wheels 6, 6′ is significantly reduced compared with FIG. 5 a). The pressure P₃ exerted against the ground by the wheels 6, 6′ of the tractor trailer shown in FIG. 5 b) is significantly decreased due to the use of the track device 8.

The track device 8, however, exerts a pressure P₂ against the ground. This pressure P₂ is lower than the pressure P₃ exerted against the ground by the first set of wheels 6 and by the second set of wheels 6′ because the contact area of the track device is significantly larger than the contact area of the wheels 6, 6′.

It can be seen that the vehicle 2 provided with a track device 8 is capable of reducing the pressure exerted against the ground significantly even if the force F₃ exerted against the ground by the track device 8 in the centre area 60 is kept at a high level.

FIG. 5 c) illustrates an unloaded tractor trailer 2 according to the invention. Below the tractor trailer 2, a first and a second graph are shown. The first graph illustrates the force F exerted against the ground by the wheels 6, 6′ and the track device 8.

The first set of wheels 6 is arranged within a first side area 58 of the tractor trailer 2, whereas the second set of wheels 6′ is arranged within a second side area 58′ of the tractor trailer 2. The track device 8 is arranged in the centre area 60 between the first side area 58 of the tractor trailer 2 and the second side area 58′ of the tractor trailer 2.

The force F₃ exerted against the ground by the track device 8 in the centre area 60 is the same as in FIG. 5 b) in which the tractor trailer 2 is loaded. The force F₁ exerted against the ground by the wheels 6 within the first side area 58 of the tractor trailer 2 and by the wheels 6′ within the second side area 58′ of the tractor trailer 2 is indicated in the first graph.

It can be seen that the force F₁ exerted against the ground by the wheels 6, 6′ is significantly lower than the force F₂ exerted against the ground by the wheels 6, 6′ in FIG. 5 b).

The second graph illustrates that the pressure P₁ exerted against the ground by the first set of wheels 6 corresponds to the pressure exerted against the ground by the second set of wheels 6′, and that this pressure P₁ is significantly lower than the pressure P₂ exerted against the ground by the wheels 6, 6′ of the loaded tractor trailer 2 illustrated in FIG. 5 b).

Furthermore, the second graph illustrates that the pressure P₂ exerted against the ground by the track device 8 corresponds to the pressure exerted against the ground by the track device 8 of the loaded tractor trailer 2 illustrated in FIG. 5 b).

When FIG. 5 c) is compared to FIG. 5 b), it can be seen that the pressure P₂ exerted against the ground by the track device 8 is the same when the tractor trailer 2 is loaded (FIG. 5 b) and when the tractor trailer 2 is unloaded (FIG. 5 c), respectively. This may be accomplished by applying a control method in which the force F₃ and thus the pressure P₂ exerted against the ground by the track device 8 are kept constant.

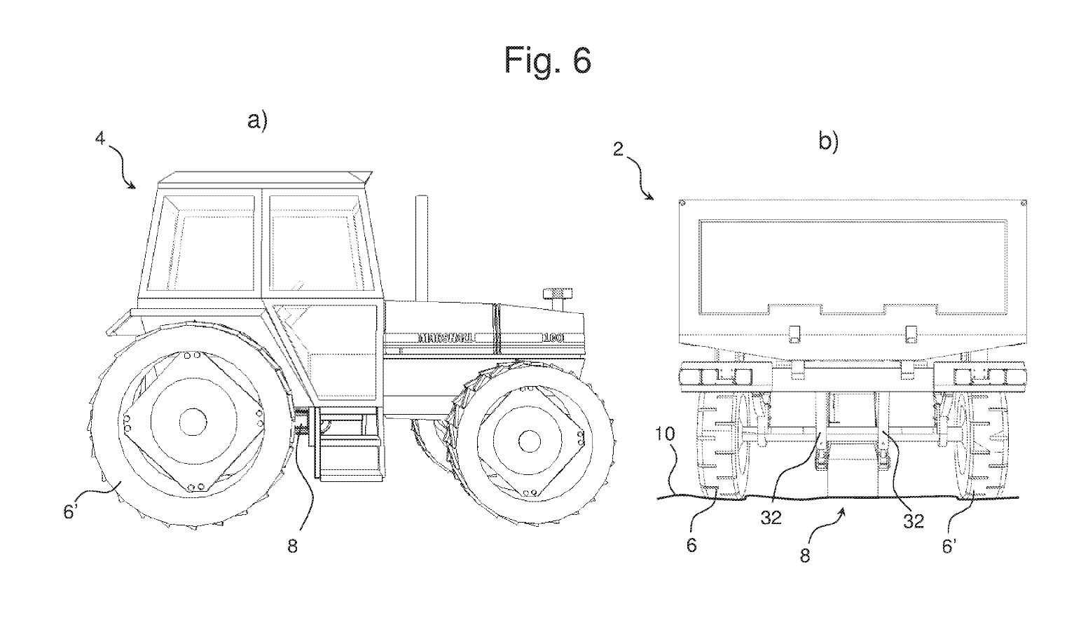

FIG. 6 a) illustrates a schematic view of a motorised vehicle 4 according to the invention. The motorised vehicle 4 is a tractor comprising two front wheels and two rear wheels 6′. The tractor 4 is provided with a track device 8 mounted between the two rear wheels 6′ (only one of the rear wheels is visible on FIG. 6).

The track device 8 mounted on either a motorised vehicle or on a non-motorised vehicle may be controlled by several control methods. It is possible to connect the track device 8 to the hydraulic system of the vehicle (e.g. a tractor) or to the hydraulic system of the vehicle (e.g. a tractor) pulling the vehicle. However, the track device 8 may be electrically driven. It is possible to apply a generator that can be attached to the power take-off (PTO) shaft of a tractor or another vehicle.

The track device 8 may be configured to be arranged in a first configuration in which the track member 22 of the track device 8 is positioned in a non-zero distance from the ground and in a second configuration in which the track member 22 of the track device 8 engages the ground.

It is possible to apply a predefined pressure when the track member 22 of the track device 8 engages the ground.

The vehicle according to the invention may comprise a control system configured to vary the pressure with which the track member 22 of the track device 8 engages the ground. In one embodiment of a vehicle according to the invention, the control system may be configured to receive information indicating the road grip of the vehicle.

Hereby, it is possible to adjust the pressure with which the track member 22 of the track device 8 engages the ground on the basis of the information indicating the road grip of the vehicle. It is possible to apply a flexible track device member (belt) or interlocking metal segments or the threads from a used tractor tyre.

FIG. 6 b) illustrates a back view of a tractor trailer 2 according to the invention. The tractor trailer 2 comprises two wheels 6, 6′ and a track device 8 mounted in the centre area between the first side area (in which the left wheel 6 is mounted) and the second side area (in which the right wheel 6′ is mounted) in closer distance to the central portion of the tractor than to the first side area and the second side area.

The track device 8 has been brought into engagement with the ground 10, and accordingly a pressure is exerted against the ground 10 by the track device 8. The track device 8 comprises two parallel hydraulic cylinders 32 that have been extended in order to bring the track device 8 into engagement with the ground 10.

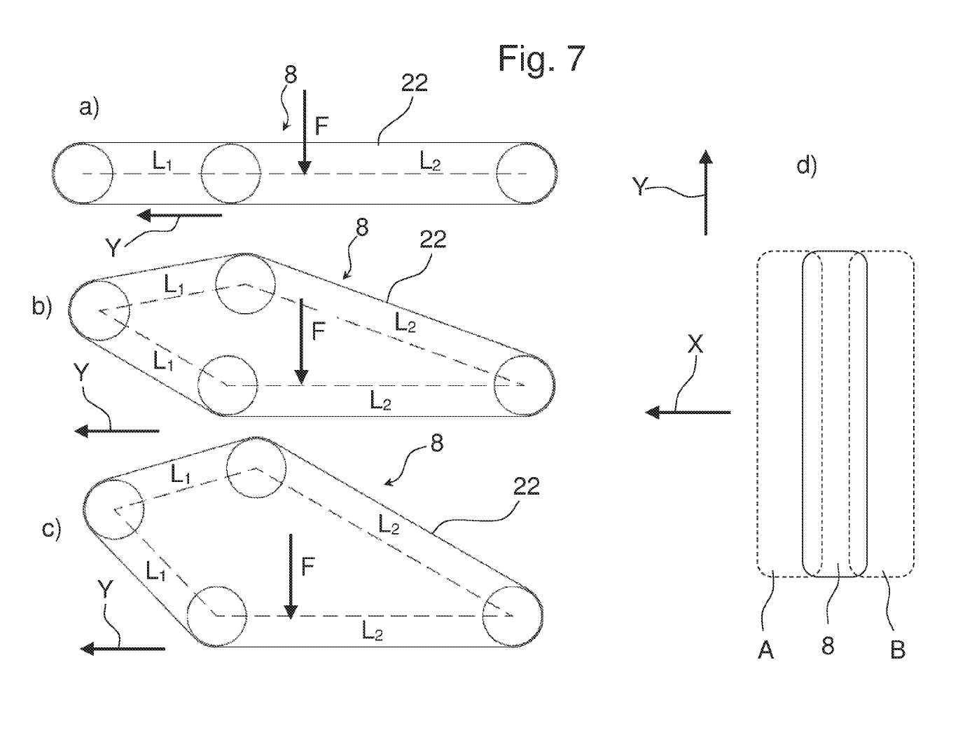

FIG. 7 a) illustrates a schematic side view of a track device 8 of a vehicle according to the invention in a “normal operation mode configuration”. The track device 8 comprises a track device member 22 (a belt) arranged along the periphery of a plurality of wheels. The forward direction Y is indicated by an arrow Y. The track device 8 comprises a first segment having a first length L₁ and a second segment with a second length L₂. A force F is applied in order to press the track device 8 towards the ground.

In FIG. 7 b), it is shown that the track device 8 can be brought into another operation mode configuration by changing the configuration of the track device member 22 (the belt). The track device 8 is brought into a configuration in which the front portion of the track device 8 having the length L₁ is angled relative to the (remaining) rear portion of the track device 8 having the length L₂.

This may be done when driving on soft ground (e.g. mud) in order to prevent the track device from getting under ground level. The circumference of the track device member 22 is kept constant since the distance between the wheels indicated is kept constant (L₁ and L₂ respectively).

FIG. 7 c) illustrates the track device 8 in a slightly other configuration. This configuration may be an advantage when a vehicle is driving in a very soft area (e.g. in mud).

The vehicle on which the track device 8 is mounted may comprise any suitable means for changing the configuration of the track device 8. The means may be hydraulic drive means or electric drive means by way of example. The front portion of the track device 8 having the length L₁ is angled more relative to the (remaining) rear portion of the track device 8 having the length L₂ than in FIG. 7 b).

FIG. 7 d) illustrates a schematic top view of a track device 8 of a vehicle according to the invention. It can be seen that the track device 8 can be displaced along the axis X extending perpendicular to the direction of travel Y. The track device 8 may be displaced into a first position A or into a second position B as indicated with dotted lines.

Hereby, the track device 8 can be displaced in order to fit the specific distances between rows of cultivated plant (e.g. berry trees, beets, potatoes, wheat, oats, or corn and other grain crops).

The vehicle according to the invention may comprise means for visually detecting the distance between rows of cultivated plant. The vehicle may further comprise means for displacing the track device 8 in order to fit the detected distance between the rows.

Any suitable means may be applied to displace the track device 8 and hereby change the configuration of the track device 8. The means may be hydraulic drive means or electric drive means by way of example.

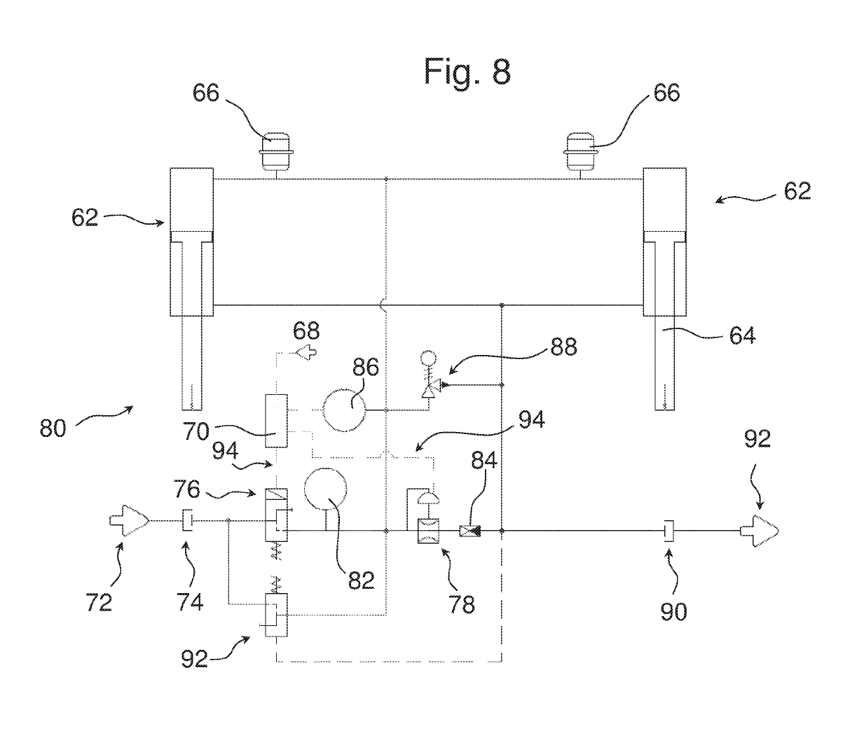

FIG. 8 illustrates a diagram of a proportional, integral and derivative (PID) control 80 comprising two hydraulic cylinders 62, each provided with a piston 64 configured to press the track device according to the invention towards the ground.

The PID control 80 comprises two pressure compensators 66 in fluid communication with the hydraulic cylinders 62. The pressure compensators 66 may be filled with air, nitrogen or helium. The pressure compensators 66 are in fluid communication with the track device of the invention and the pressure compensators 66 are configured to reduce peak forces caused by the track device when driving over bumps and holes.

The connection points 72, 94 are configured to be connected to the hydraulic system of a vehicle (e.g. a tractor). In order to activate the track device according to the invention, hydraulic oil is pumped through the connection point 72, and the connection point 94 is opened (e.g. by means of a valve) in order to allow hydraulic oil to flow into a hydraulic tank (return line). A first coupling 74 is indicated next to the connection point 72, while a second connection point 90 is indicated next to the connection point 92.

By adjusting the variable set point 68 at the control box 70, one can open the control valve 76 in order to send oil to the high pressure side of the cylinders 62. This will force the track device to be moved towards the ground until the oil pressure measured by the pressure transmitter 86 equals the set point 68. A dead band of approximately 10 bar may be accepted to avoid constant operation of the control valve 76. The control box 70 sends electrical control signals 94 (indicated by a dotted line) to the control valve 76 and to the constant pressure valve 78.

An adjustable constant pressure valve 78 will drain oil from the cylinders 62 if the set point 68 pressure is lower than the pressure measured by the pressure transmitter 86. Further, the control valve 76 will add additional oil if the set point pressure 68 is larger than the pressure measured by the pressure transmitter 86. A manometer 82 is installed in order to provide visual inspection of the pressure within the system.

The pressure compensators 66 have accumulator-capacity to absorb shocks cause by the track device when being in contact with bumps and holes.

In order to lower the track device, oil is alternated on the hydraulic connection point 72, 92. A pilot-operated non-return-valve 92 ensures that oil is drained from the pressure side of the cylinders 62 bypassing the control valve 76.

The system comprises a safety valve 88 and a non-return valve 84 arranged next to the constant pressure valve 78

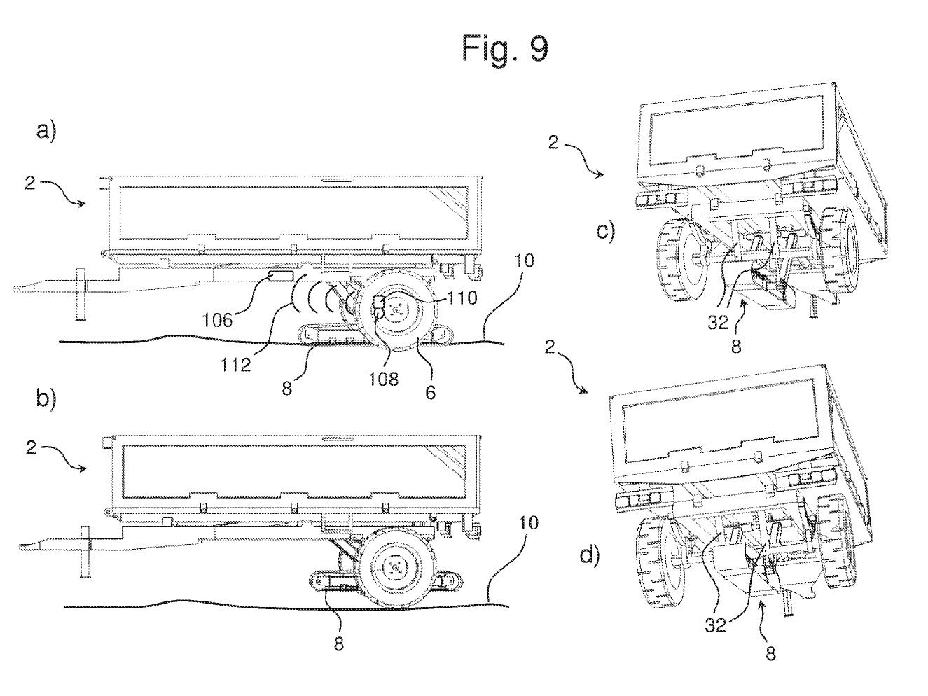

FIG. 9 a) illustrates a side view of a tractor trailer 2 according to the invention. The tractor trailer 2 comprises a track device 8 that has been brought into engagement with the ground 10. The vehicle 2 is provided with a control box 106 adapted to activate activation means (e.g. a hydraulic cylinder or an electric actuator) in order to change the vertical position of the track device 8 and/or the pressure with which the track device 8 engages the ground 10.

The vehicle 2 comprises a tyre pressure sensor 110 provided at the wheel 6 and a velocity sensor 108 attached to the wheel 6. The tyre pressure sensor 110 and the velocity sensor 108 are configured to wirelessly communicate with the control box 106. It can be seen that the tyre pressure sensor 110 and the velocity sensor 108 send wireless signals 112 to the control box 106.

Accordingly, the tyre pressure sensor 110 and the velocity sensor 108 can detect pressure and velocity data and send????? the data to the control box 106. The control box 106 can determine if the pressure with which the track device 8 engages the ground 10 should be unchanged or changed (increased or decreased). By way of example, the control box 106 may be configured to receive information about the speed of the vehicle and at the same time receive information from the velocity sensor 108. If the control box 106 detects that the speed of the vehicle exceeds the speed of the wheel 6, it can be concluded that the road grip is poor. Accordingly, the control box 106 can control the actuator (e.g. a hydraulic cylinder) connected to the track device 8 to reduce the pressure with which the track device 8 engages the ground 10.

Hereby, the normal force acting between the wheel 8 and the ground 10 will be increased, and the friction force will consequently be increased. Accordingly, a sufficient road grip for driving the vehicle 2 can be achieved.

FIG. 9 b) illustrates a side view of a tractor trailer 2 according to the invention. The tractor trailer 2 comprises a track device 8 that has been brought out of engagement with the ground 10.

FIG. 9 c) illustrates a perspective back view of the tractor trailer 2 shown in FIG. 9 a). The tractor trailer 2 comprises a track device 8 having two parallel hydraulic actuators 32 that have been extended in order to bring the track device 8 into engagement with the ground 10.

FIG. 9 d) illustrates a perspective back view of the tractor trailer 2 shown in FIG. 9 b). The tractor trailer 2 comprises a track device 8 having two parallel hydraulic actuators 32 that are not fully extended.

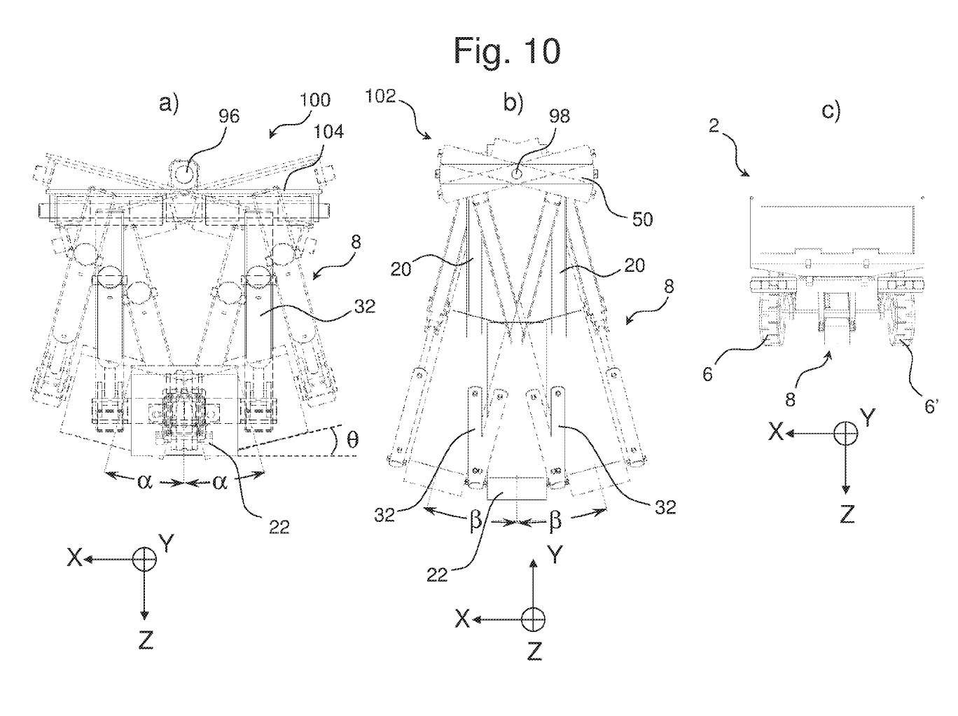

FIG. 10 a) illustrates a track device 8 according to the invention mounted on a first rotation device 100 according to the invention. Below the first rotation device 100, a Cartesian coordinate system with three axes X, Y, Z is shown. The axis Y indicates the direction of travel, the axis X is the lateral direction, while the axis Z indicates the vertical direction.

The first rotation device 100 comprises a base member 104 rotatably mounted to a shaft member 96 extending along the horizontal axis Y. The track device 8 comprises two hydraulic actuators 32 extending between the track member 22 and the base member 104 of the rotation device 100.

During normal operation, the hydraulic actuators 32 extend vertically. If required, the track member 22 and thus the hydraulic actuators 32 can be rotated about the direction of travel Y. Hereby, an angular displacement of the hydraulic actuators 32 will occur. In FIG. 10 a), two angular displacements are indicated (with dotted lines). The angular displacements correspond to the indicated angle α.

This rotation will cause the track device 8 to be angled (θ) relative to horizontal. Rotation of the rotation device 100 may be accomplished by means of any suitable hydraulic or electrical means. The control of the rotation device 100 may be carried out by means of one or more detected parameters e.g. measurements provided by means of sensors.

FIG. 10 b) illustrates a track device 8 according to the invention mounted on a second rotation device 102 according to the invention. A Cartesian coordinate system with three axes X, Y, Z is illustrated below the second rotation device 102. Like in FIG. 10 a), the axis Y indicates the direction of travel, the axis X is the lateral direction, while the axis Z indicates the vertical direction.

The second rotation device 102 comprises an attachment member 50 rotatably mounted to a shaft member 98 extending along the vertical axis Z. The track device 8 comprises two hydraulic actuators 32 extending between the track member 22 and the attachment member 50.

During normal operation, the suspension members 20 extend along the direction of travel Y. If required, the track member 22 and thus the hydraulic actuators 32 can be rotated about the direction of travel Y. Hereby, an angular displacement of the suspension members 20 will take place. In FIG. 10 b), two angular displacements are indicated with dotted lines. The angular displacements are indicated with an angle 3. This rotation will make it easier to turn the vehicle on which the track device 8 is mounted.

It may be an advantage to apply a hydraulic or electrical actuator to move (rotate) the rotation device 102.

FIG. 10 c) illustrates a tractor trailer 2 according to the invention seen from the rear end. The tractor trailer 2 is provided with a first wheel 6 and a second wheel 6′ and a track device 8 according to the invention arranged in the centre area between the wheels 6, 6′.

A Cartesian coordinate system with three axes X, Y, Z is illustrated below the tractor trailer 2. Like in FIG. 10 a) and in FIG. 10 b), the axis Y indicates the direction of travel, the axis X is the lateral direction, while the axis Z indicates the vertical direction.

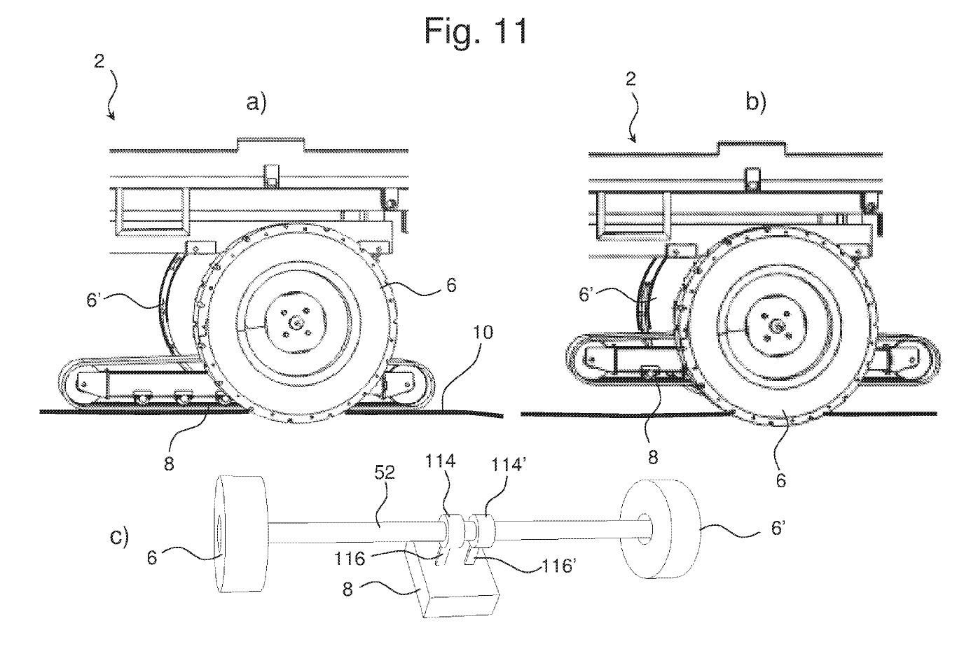

FIG. 11 A) illustrates a schematic side view of a portion of a vehicle 2 according to an embodiment of the invention. The vehicle 2 comprises a track device 8 arranged below the rotating shaft connecting the first wheel 6 and the second wheel 6′ of the vehicle. The track device 8 is arranged to support the portion of the shaft that extends between the first wheel 6 and the second wheel 6′ of the vehicle 2. Accordingly, the track device 8 can relieve the pressure with which the wheel 6, 6′ engage the ground 10.

FIG. 11 b) illustrates a schematic side view of the vehicle 2 shown in FIG. 11 a) in a configuration in which the track device 8 does not engage the ground 10.

FIG. 11 c) illustrates a schematic view of a track device 8 attached to a shaft 52 extending between a first wheel 6 and a second wheel 6′ by means of a first attachment member 114 and a second attachment member 114′ connected to the track device 8 by means of a first connection member 116 and a second connection member 116′. The connection members 116, 116′ may be a telescopic mechanical actuator, such as a hydraulic cylinder.

### LIST OF REFERENCE NUMERALS

2 Vehicle (e.g. tractor trailer)
4 Motorised vehicle
6, 6′ Wheel
8 Track device
10 Ground
12 Frame member
14 Support member
16 Tipping member (telescopic arm)
18 Box member
20 Suspension member
22 Track member
24 Rear wheel
26 Front wheel
28 Top support wheel
30 Bottom support wheel
32 Actuator
34 Connection member
34′, 34″ Connection element
36 Base member
38 Second end portion
40 First end portion
42, 44 Joint
46, 48 Track device member
50 Attachment member
52 Shaft member
54 End portion
56 Central portion
58, 58′ Side area
60 Centre area
62 Hydraulic cylinder
64 Piston
66 Pressure compensator
68 Set point
70 Control box
72 Hydraulic connection point
74 Hydraulic coupling
76 Control valve
78 Constant pressure valve
80 Proportional, integral and derivative control
82 Manometer
84 Non-return valve
86 Pressure transmitter
88 Safety valve
90 Hydraulic coupling
92 Hydraulic connection point
94 Electrical control signal
96, 98 Shaft member
100, 102 Rotation device
104 Base member
106 Control box
108 Sensor
110 Sensor
112 Signal
114, 114′ Attachment member
116, 116′ Connection member
α, β Angular displacement
θ Angle
P, P₁, P₂, P₃ Pressure
F, F₁, F₂, F₃, F₄ Force
X, Y, Z Direction
A, B Position
F, F₁, F₂, F₃ Force
L₁, L₂ Length

1. A vehicle comprising at least a first wheel mounted in a first side area of the vehicle and a second wheel mounted in a second side area of the vehicle, which vehicle comprises a track device configured to be brought into engagement with the ground, wherein the vehicle comprises a control member configured to adjust a pressure with which the track device engages the ground, wherein the pressure is determined on the basis of measurements performed by one or more detection members configured to detect one or more variable parameters of the vehicle.

2. The vehicle of claim 1, wherein the one or more variable parameters of the vehicle are one or more of the following:
a) slippage and/or road grip of one or more of the wheels;
b) he axle load and/or the load of the vehicle or of a container of the vehicle;
c) tyre pressure of one or more of the wheels;
d) measured motor power and/or the velocity of the vehicle;
e) visual detection of the content in a container;
f) pressure in a structure;
g) distance from a predefined position to an object.

3. The vehicle of claim 1, wherein the vehicle comprises a control member configured to adjust the pressure with which the track device engages the ground on the basis of geographical data measured by a sensor member of the vehicle or received by the vehicle.

4. The vehicle of claim 1, wherein the vehicle comprises means for bringing the track device into a configuration in which the track device is not in engagement with the ground.

5. The vehicle of claim 1, wherein the track device is motorized for driving the track device.

6. The vehicle of claim 1, wherein the track device is detachably mounted to the vehicle.

7. The vehicle of claim 1, wherein the track device is displaceable along an axis extending perpendicular to the direction of travel.

8. The vehicle of claim 1, wherein the track device is movably, e.g. slidably, arranged at the vehicle in such a manner that the track device may be rearranged.

9. The vehicle of claim 1, wherein the vehicle comprises means for ensuring that the track device engages the ground with a predefined pressure defined on the basis of measurements made by the vehicle.

10. The vehicle of claim 1, wherein the track device is arranged below a shaft connecting the first wheel and the second wheel of the vehicle.

11. The vehicle of claim 10, wherein the track device is arranged to support a portion of the shaft that extends between the first wheel and the second wheel of the vehicle.

12. A method for controlling a tracked and wheeled vehicle comprising a track device configured to be brought into engagement with the ground, which vehicle comprises a control member configured to adjust a pressure with which the track device engages the ground, wherein the method comprises the steps of:
detecting one or more variable parameters measured by one or more detection members;
adjusting the pressure with which the track device engages the ground on the basis of the detected parameter(s) or external information received by the vehicle.

13. The method of claim 12, wherein the one or more variable parameters measured by one or more detection members are one or more of the following:
a) slippage and/or road grip of one or more of the wheels;
b) axle load and/or the load of the vehicle or of a container of the vehicle;
c) tyre pressure of one or more of the wheels;
d) measured motor power and/or the velocity of the vehicle;
e) visual detection of the content in a container;
f) pressure in a structure;
g) distance from a predefined position to an object.

14. The method of claim 12, wherein the method comprises the step of adjusting the pressure with which the track device engages the ground on the basis of geographical data measured by a sensor member of the vehicle or received by the vehicle.

15. The method of claim 14, wherein the geographical data comprises information about the soil type of the ground at the area below and/or around the vehicle.
